(19) United States
(12) Patent Application Publication
(10) Pub. No.: US 2015/0310388 A1
(43) Pub. Date: Oct. 29, 2015

(54) LOCAL COURIERS NETWORK IN THE CONTEXT OF AN ON-LINE TRADING PLATFORM

(71) Applicant: Sudha Jamthe, San Jose, CA (US)

(72) Inventor: Sudha Jamthe, San Jose, CA (US)

(21) Appl. No.: 14/263,856

(22) Filed: Apr. 28, 2014

(51) Int. Cl. G06Q 10/08; G06Q 30/06; H04L 29/08

(52) U.S. Cl. CPC G06Q 10/08345; H04L 67/10; G06Q 30/0611; G06Q 30/0635

(57) ABSTRACT

A local couriers network provided in the context of an on-line trading platform is described. A request detector receives, from a user, a purchase request indicating an item. A local delivery indication detector determines, from the purchase request, an indication of a local delivery transaction. A local courier selector selects courier identifications corresponding to one or more profiles from the local courier profiles in response to the indication of the local delivery transaction, utilizing respective quality of service ratings stored in the local courier profiles. The communications module provides the list to the user and receives, from the user, a chosen courier identification and completes a transaction with respect to purchase and delivery of the item.

### TECHNICAL FIELD

This application relates to the technical fields of software and/or hardware technology and, in one example embodiment, to a local couriers network.

### BACKGROUND

An on-line trading platform allows users to shop for almost anything using, e.g., a web browser application or an application native to a mobile device. A user may find an item listed by an on-line trading application by entering keywords into the search box provided on an associated web page or by browsing through the list of categories on the home page. After reading the item description and viewing the seller's reputation, the user may be able to either place a bid on the item or purchase it instantly. There are many features provided by an on-line trading application that may be utilized by users in unique ways that may result in a successful shopping experience. A user may encounter an item of interest on a web site other than a web site associated with the on-line trading platform. The user may be able to determine keywords that describe that item of interest, access the web site associated with the on-line trading platform and attempt to locate that item in the on-line trading platform.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example local couriers network may be implemented;

FIG. 2 is block diagram of a system to utilize a local couriers network, in accordance with one example embodiment;

FIG. 3 is a flow chart of a method to utilize a local couriers network, in accordance with an example embodiment; and

FIG. 4 is a diagrammatic representation of an example machine in the form of a computer system, within which a set of instructions, for causing the machine to perform any one or more of the methodologies discussed herein, may be executed.

### DETAILED DESCRIPTION

Method and system are provided for utilizing a local couriers network. In the following description, for purposes of explanation, numerous specific details are set forth in order to provide a thorough understanding of example embodiments. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

An on-line trading platform may include a service that permits buyers to request local delivery of goods, where the item being purchased is located close enough so that it can be delivered by a local courier within a short period of time, e.g., within one hour. This service may be provided as a so-called local delivery system. In a scenario where an item is delivered to a buyer by a local courier, the quality of the service provided by the courier may be almost as important to the user, as the quality of the item itself.

In one embodiment, an on-line trading platform may be provided with a courier feedback system for collecting, processing, and utilizing data with respect to local couriers. Members of an on-line trading platform who represent themselves as local couriers may be included in a so-called local couriers network (also referred to as a network of local couriers) within the on-line trading platform. The front-end of the on-line trading platform may include a user interface for collecting feedback data with respect to couriers and the back-end of the on-line trading platform may include modules for processing the collected feedback data and to generate quality of service ratings (also referred to as merely ratings) for respective local couriers. The feedback data requested from buyers regarding a local courier may include ratings with respect to the promptness of delivery, courteousness of the courier, etc. The quality of service ratings may be stored in a database accessible and/or maintained by the on-line trading platform and may be exposed to prospective buyers in order to aid them in selecting a local courier for effectuating delivery of goods. A courier feedback system may be part of the local delivery system, which, in turn, may be part of an on-line trading platform.

In operation, when a user requests an item listed in the on-line trading platform and indicates that they would like to purchase the item utilizing the local delivery service (e.g., a one-hour delivery by a local courier), the local delivery system may notify local couriers from the couriers network of the request and permit those couriers to bid on the job of delivering the requested item to the user. The bids may be presented to the user, via a user interface (UI), together with the information about respective couriers, such that the user may select one of the couriers from the list. In one embodiment, the local delivery system may be configured to contact only those couriers, whose quality of service rating is above a predetermined threshold value. In another embodiment, the local delivery system, in response to a request from a user to purchase an item utilizing the local delivery service, may present a list of couriers to the user together with the couriers' respective ratings without contacting the couriers first. The local delivery system may also provide a user interface to receive, from a user a lower threshold value with respect to an acceptable quality of service rating assigned to a courier. For example, if a quality of service rating is a value between one and ten, a user may indicate that they do not wish to engage a courier with a rating that is lower than six. The local delivery system would then omit presenting to the user the identifications of those couriers, whose quality of service rating is below six. In some embodiment, a user can choose a courier based on other types of ratings, such as, e.g., time from order to delivery, cost, feedback ratings, delivery operating range, operating hours, etc. These individual ratings may be combined using a weighted scale to generate an overall quality of service rating. For example, if the cost is a major factor to the user, the cost rating may be associated with a higher weight.

Once the user selects a courier from the presented list, the transaction is completed and, after the item has been delivered to the user by the selected courier, the user may be asked to provide feedback with respect to the delivery of the item by the courier. If the user chooses to submit feedback the feedback is combined with the existing feedback data for that courier to generate the updated quality of service rating for the courier. Both the feedback data and respective quality of service ratings for couriers in the local couriers network may be stored in a database.

In one embodiment, an on-line trading platform may be provided with a system for identifying those users who have propensity for shopping locally by utilizing the local delivery service and, based on that information, target those users for special offers and/or enhanced services. For example, a user's transactional data stored by the on-line trading platform may be examined by the local delivery system to determine which items have been purchased by the user, where they were shipped, what was the time of purchase, etc. Those users, who tend to make their purchases within a certain distance from their shipping address, may be categorized by the local delivery system as local shoppers. For example, the criteria for a local shopper may require that 80% of the user's purchases in the on-line trading platform within a period of time are shipped within 20 miles from their perceived location.

Certain item listings in an on-line trading platform may be categorized as local merchandise. For example, a listing for an item that is likely to be needed immediately, e.g., a medical accessory like a cast protector or an electronic accessory like, e.g., a projector cable, may be categorized as a local delivery item. The users that have been categorized as local shoppers may be presented with offers related to items categorized as local delivery items.

In one embodiment, an on-line trading platform may include or cooperate with a so-called concierge system that processes requests for local purchases. A local concierge system may be configured to map those users of the on-line trading platform that have been categorized as local shoppers to a set of local couriers from the local couriers network as their concierge. Those users, who have been categorized as local shoppers, may be presented with an option to submit their shopping requests to a concierge. For example, a user who has been categorized a local shopper in the on-line trading platform may have access to a “concierge service” visual control, where activating such visual control results in presenting the user with a user interface that allows the user to communicate their exact shopping needs to the network of couriers in the on-line trading platform.

The concierge service system may be configured to communicate the shopping request from submitted by a local shopper to the network of local couriers, and to receive bids from the couriers, together with other information from respective profiles of the couriers. The data from respective profiles of the couriers may include respective quality of service ratings of the couriers, as well as other information, such as, e.g., a particular area of expertise of a local courier. For example, some couriers may specialize in electronics, while others may specialize in fashion, as a courier acting as a concierge has to understand the user's need in order to get for the users what they need, in order to be able to suggest alternates and to complete the shipping/delivery within the time constraints specified by the user.

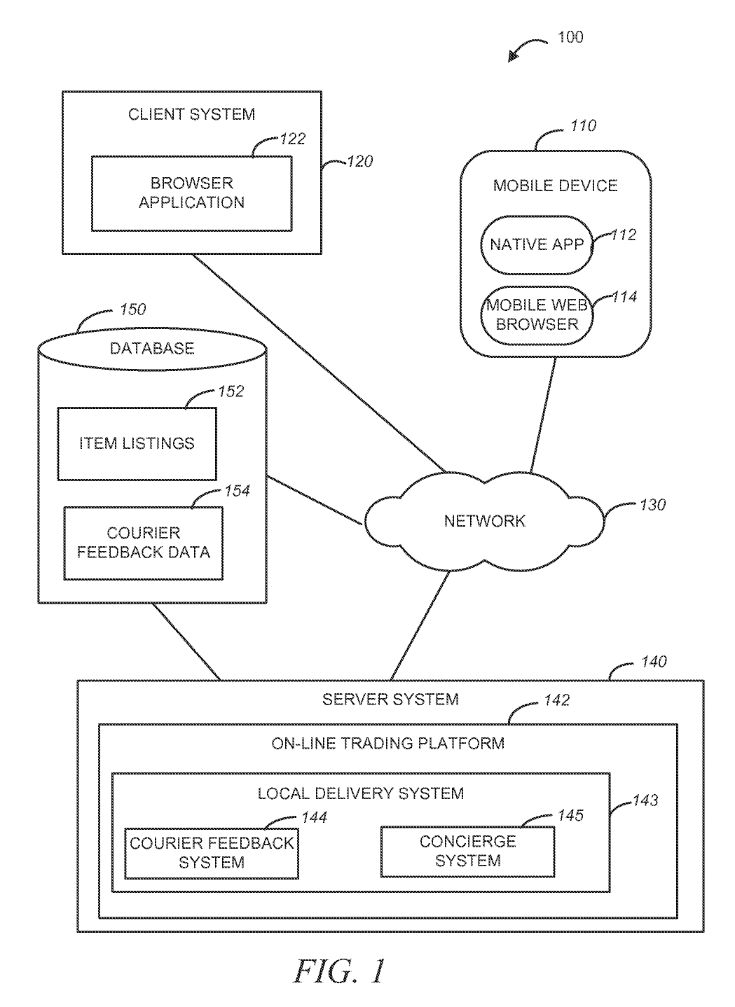

An example local couriers network may be implemented in the context of a network environment 100 illustrated in FIG. 1. As shown in FIG. 1, the network environment 100 may include client devices 110 and 120, and a server system 140. The client device 110 may be a mobile device and may be executing a native app 112 and/or a mobile web browser 114. The native app 112 may be providing access to services executing on the server system 140, such as, e.g., to services provided by the on-line trading platform 142. The client device 120 may be a desktop device and may be executing a browser application 122. The client devices 110 and 120 may have access to the server system 140 hosting the on-line trading platform 142 via a communications network 130. The communications network 130 may be a public network (e.g., the Internet, a mobile communication network, or any other network capable of communicating digital data). The on-line trading platform 142 may be configured to retrieve commerce item listings 152 stored in a storage system 150 and to provide the retrieved listings to users for viewing.

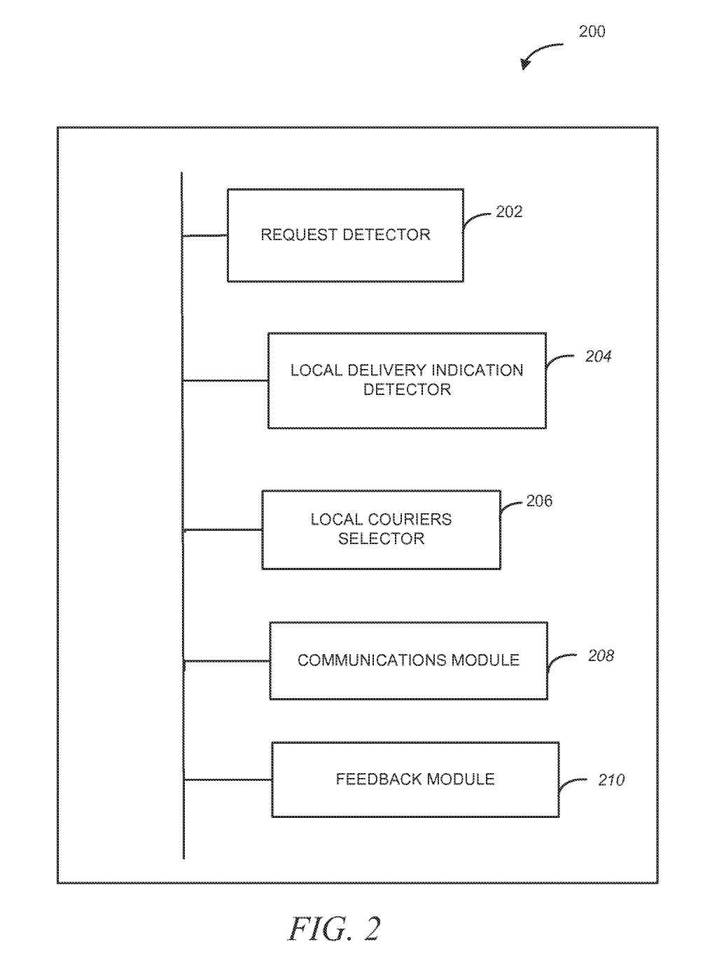

The on-line trading platform 142 may include a local delivery system 143. The local delivery system 143 may be configured to maintain a network of local couriers and provide users with local delivery of goods being purchased in the on-line trading platform 142. Also shown in FIG. 1 are a courier feedback system 144 and a concierge system 145. Although the courier feedback system 144 and the concierge system 145 are shown as part of the local delivery system 143, in some embodiments, either of these systems may be implemented as stand-alone system that cooperate with the local delivery system 143 and/or with the on-line trading system 142. Feedback data collected by the courier feedback system 144 with respect to couriers in the local couriers network, as well as the associated quality of service ratings may be stored in the database 150 as courier feedback data 154. The concierge service system 145 may be configured to provide concierge service to those users of the on-line trading platform 142, who have been identified as local shoppers the on-line trading platform 142, based on their transaction history or, e.g., based on their request to be identified as local shoppers the on-line trading platform 142. Some modules that may be included in the local delivery system 143, in the courier feedback system 144, and the concierge system 145 may be described with reference to FIG. 2.

FIG. 2 is a block diagram of a system 200 to utilize a network of local couriers, in accordance with one example embodiment. In one embodiment, the system 200 corresponds to the local delivery system 143 of FIG. 1. As shown in FIG. 2, the system 200 includes a request detector 202, a local delivery indication detector 204, a local courier selector 206, a communications module 208, and a feedback module 210.

The request detector 202 may be configured to receive, from a user represented by a user identification, a purchase request indicating an item available for purchase via the on-line trading platform 142 of FIG. 1. The on-line trading platform 142 may be configured to maintain local courier profiles representing respective providers of local courier service. The local courier profiles may include information about the courier such as, identifying information, street address or location, geographic area that can be serviced by the courier, a particular area of expertise, etc. The local courier profiles may be stored in the database 150 of FIG. 1 and may include or reference respective quality of service ratings that may be generated based on feedback provided by users of the on-line trading platform 142.

The on-line trading platform 142 may be configured to maintain various categories with respect to users of the on-line trading platform 142, as well as with respect to item listings or item identifications. For example, the on-line trading platform 142 may maintain a local shopper category that identifies those users that tend to use the local delivery service provided by the on-line trading platform 142 and a local delivery items category that identifies those items available for purchase in the on-line trading platform 142 that lend themselves for local delivery (e.g., items that often are needed urgently).

The local delivery indication detector 204 may be configured to determine, from a purchase request received from a user of the on-line trading platform 142, an indication of a local delivery transaction. A local delivery transaction is a transaction that involves a local delivery by means of a local courier. An indication of a local delivery transaction may be based on determining that the user identification associated with the purchase request is associated with a local shopper category. The local delivery indication detector 204 may be configured to examine purchases history data associated with the user identification and, based on the purchases history data, associate the user identification with the local shopper category. The local delivery indication detector 204 may also be configured to determine that the item indicated in the purchase request is a local delivery item from a local delivery items category.

The local courier selector 206 may be configured to select courier identifications corresponding to one or more profiles from the local courier profiles that may be maintained by the on-line trading platform 142 in the database 150, in response to the indication of the local delivery transaction. The local courier selector 206 may utilize respective quality of service ratings of couriers represented by the profiles and, based on the respective quality of service ratings, select only those couriers that have their quality of service rating above a certain threshold value. A threshold value may be predetermined by the local delivery system or obtained from a user who originated the purchase request. The local courier selector 206 may be configured to exclude, from the list, a courier identification associated with a quality of service rating that is less than the lowest acceptable quality of service rating value.

The communications module 208 may be configured to provide, to the user, a list of the selected courier identifications corresponding to one or more profiles from the local courier profiles. The communications module 208 may also be configured to obtain, from couriers represented by the respective selected courier identifications, bids for delivery of the item identified in the purchase request and provide the bids to the user, e.g., via a user interface, such that the user can select a courier identification based on their respective bids. The communications module 208 may be configured to receive, from the user, a chosen courier identification from the list and complete a transaction in the on-line trading platform 142 with respect to purchase and delivery of the item.

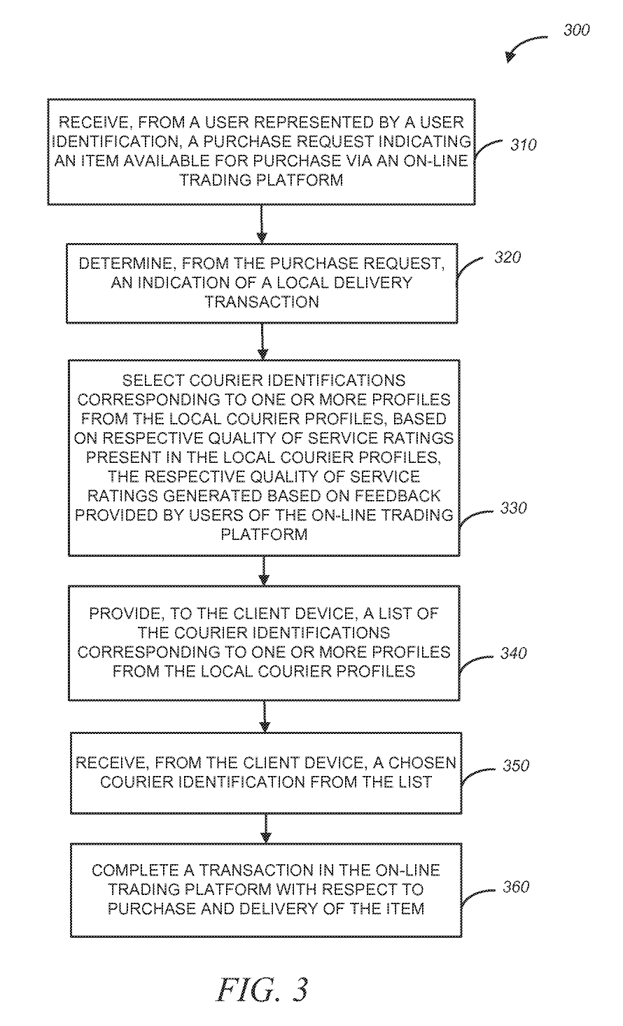

Also shown in FIG. 2 is the feedback module 210. The feedback module 210 may be configured to obtain, from a user of the on-line trading platform 142, feedback regarding a particular local courier represented by a courier identification and a profile, and to update quality of service rating stored in the profile associated with the particular local courier, based on the obtained feedback. Example operations performed by the system 200 are described with reference to FIG. 3.

FIG. 3 is a flow chart of a method 300 to utilize a network of local couriers, in accordance with one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1.

As shown in FIG. 3, the method 300 commences at operation 310, when the request detector 202 of FIG. 2 receives, from a user represented by a user identification, a purchase request indicating an item available for purchase via the on-line trading platform 142 of FIG. 1, at operation 310. At operation 320, the local delivery indication detector 204 of FIG. 2 determines, from the purchase request received from a user of the on-line trading platform 142, an indication of a local delivery transaction. As explained above, an indication of a local delivery transaction may be based on determining that the user identification associated with the purchase request is associated with a local shopper category or, e.g., based on determining that the item indicated in the purchase request is a local delivery item from a local delivery items category.

At operation 330, the local courier selector 206 selects courier identifications corresponding to one or more profiles from the local courier profiles (that may be maintained by the on-line trading platform 142 in the database 150) in response to the indication of the local delivery transaction. As stated earlier, the local courier selector 206 may utilize respective quality of service ratings of couriers represented by the profiles and, based on the respective quality of service ratings, select only those couriers that have their quality of service rating above a certain threshold value. A threshold value may be predetermined by the local delivery system or obtained from a user who originated the purchase request. At operation 340, the communications module 208 of FIG. 2 provides, to the user, a list of the selected courier identifications corresponding to one or more profiles from the local courier profiles. At operation 350, the communications module 208 receives, from the user, a chosen courier identification from the list and completes a transaction in the on-line trading platform 142 with respect to purchase and delivery of the item at operation 360.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

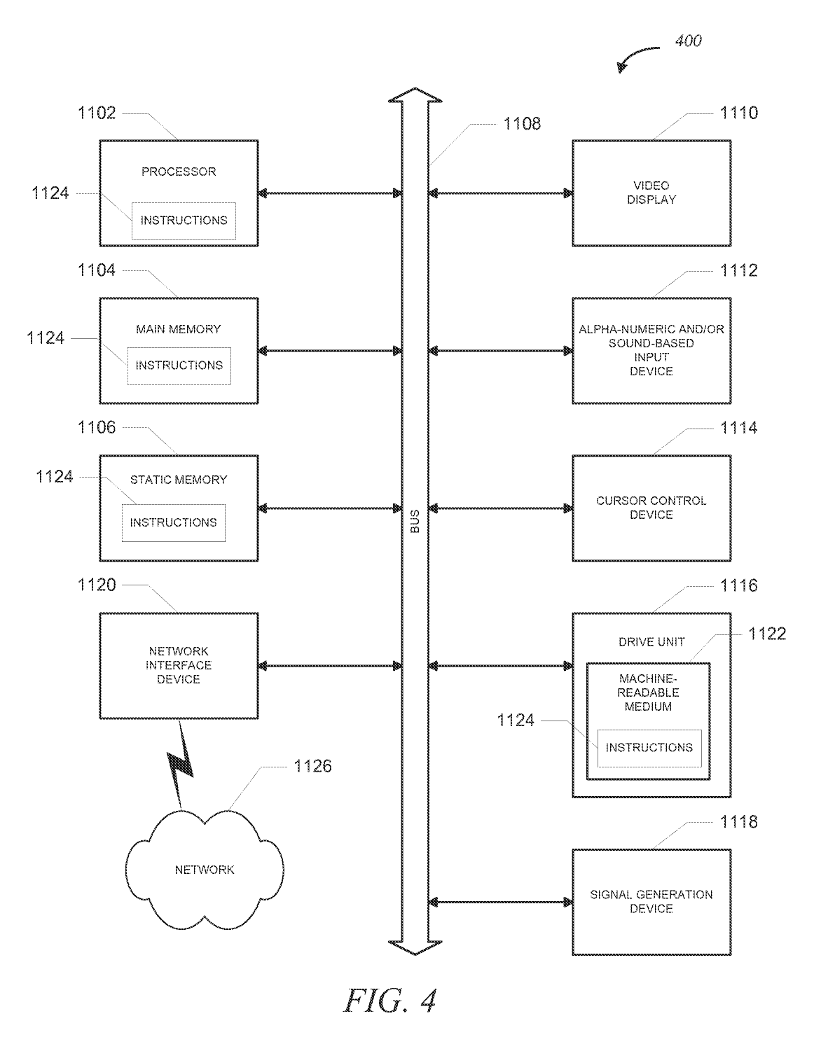

FIG. 4 is a diagrammatic representation of a machine in the example form of a computer system 1100 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 11011. The computer system 1100 may further include a video display unit 1110 (e.g., a liquid crystal display (LCD) or a cathode ray tube (CRT)). The computer system 1100 also includes an alpha-numeric and/or sound-based input device 1112 (e.g., a keyboard and/or a microphone), a user interface (UI) navigation device 1114 (e.g., a cursor control device), a drive unit 1116, a signal generation device 1118 (e.g., a speaker) and a network interface device 1120.

The drive unit 1116 includes a machine-readable medium 1122 on which is stored one or more sets of instructions and data structures (e.g., software 1124) embodying or utilized by any one or more of the methodologies or functions described herein. The software 1124 may also reside, completely or at least partially, within the main memory 1104 and/or within the processor 1102 during execution thereof by the computer system 1100, with the main memory 1104 and the processor 1102 also constituting machine-readable media.

The software 1124 may further be transmitted or received over a network 1126 via the network interface device 1120 utilizing any one of a number of well-known transfer protocols (e.g., Hyper Text Transfer Protocol (HTTP)).

While the machine-readable medium 1122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like. Furthermore, the tangible machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, a local couriers network has been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A method comprising:
receive, at a computer system, from a user represented by a user identification, a purchase request indicating an item available for purchase via an on-line trading platform, the on-line trading platform maintaining local courier profiles representing respective providers of local courier service, the local courier profiles comprising respective quality of service ratings generated based on feedback provided by users of the on-line trading platform;
determine, from the purchase request, an indication of a local delivery transaction;
in response to the indication of the local delivery transaction, select courier identifications corresponding to one or more profiles from the local courier profiles, utilizing respective quality of service ratings stored in the local courier profiles, using at least one processor; and
provide, to the user, a list of the selected courier identifications corresponding to one or more profiles from the local courier profiles.

2. The method of claim 1, comprising obtaining, from couriers represented by the respective selected courier identifications, bids for delivery of the item, the list of the selected courier identifications comprising the respective obtained bids for delivery of the item.

3. The method of claim 1, comprising:
receiving, from the user, a chosen courier identification from the list;
completing a transaction in the on-line trading platform with respect to purchase and delivery of the item; and
obtaining, from the user, feedback regarding a courier represented by the chosen courier identification; and
updating quality of service rating stored in the profile associated with the chosen courier identification based on the feedback.

4. The method of claim 1, wherein the selecting of courier identifications comprises:
receiving, from the user, a lowest acceptable quality of service rating value; and
excluding, from the list, a courier identification associated with a quality of service rating that is less than the lowest acceptable quality of service rating value.

5. The method of claim 1, comprising determining an item category associated with the item, the item category maintained by the on-line trading platform, wherein the selecting of courier identifications is based on the item category.

6. The method of claim 1, wherein the determining of the indication of a local delivery transaction comprises determining that the user identification associated with the purchase request is associated with a local shopper category, the local shopper category maintained by the on-line trading platform.

7. The method of claim 6, comprising:
examining purchases history data associated with the user identification; and
based on the purchases history data, associating the user identification with the local shopper category.

8. The method of claim 1, wherein the determining of the indication of a local delivery transaction comprises determining that the item indicated in the purchase request is a local delivery item from a local delivery items category, the local delivery items category maintained by the on-line trading platform.

9. The method of claim 1, wherein the determining of the indication of a local delivery transaction comprises detecting activation of a local delivery visual control at the client device.

10. The method of claim 1, wherein the purchase request is received from a mobile device.

11. A computer-implemented system comprising:
at least one processor coupled to a memory;
a request detector to receive, at a computer system, using the at least one processor, from a user represented by a user identification, a purchase request indicating an item available for purchase via an on-line trading platform, the on-line trading platform maintaining local courier profiles representing respective providers of local courier service, the local courier profiles comprising respective quality of service ratings generated based on feedback provided by users of the on-line trading platform;
a local delivery indication detector to determine, using the at least one processor, from the purchase request, an indication of a local delivery transaction;
a local courier selector to select, using the at least one processor, courier identifications corresponding to one or more profiles from the local courier profiles, in response to the indication of the local delivery transaction, utilizing respective quality of service ratings stored in the local courier profiles; and
a communications module to provide, to the user, using the at least one processor, a list of the selected courier identifications corresponding to one or more profiles from the local courier profiles.

12. The system of claim 11, wherein the communications module is to obtain, from couriers represented by the respective selected courier identifications, bids for delivery of the item, the list of the selected courier identifications comprising the respective obtained bids for delivery of the item.

13. The system of claim 11, wherein the communications module is to, using the at least one processor:
receive, from the user, a chosen courier identification from the list; and
complete a transaction in the on-line trading platform with respect to purchase and delivery of the item,
the system comprising a feedback module to, using the at least one processor:
obtain, using the at least one processor, feedback regarding a courier represented by the chosen courier identification, and
update quality of service rating stored in the profile associated with the chosen courier identification based on the feedback.

14. The system of claim 11, wherein:
the communications module is to receive, from the user, a lowest acceptable quality of service rating value; and
the local courier selector is to exclude, from the list, a courier identification associated with a quality of service rating that is less than the lowest acceptable quality of service rating value.

15. The system of claim 11, wherein the local courier selector is to determine an item category associated with the item and to select the courier identifications is based on the item category, the item category maintained by the on-line trading platform.

16. The system of claim 11, wherein the local delivery indication detector is to determine that the user identification associated with the purchase request is associated with a local shopper category, the local shopper category maintained by the on-line trading platform.

17. The system of claim 16, wherein the local delivery indication detector is to, using the at least one processor:
examine purchases history data associated with the user identification; and
based on the purchases history data, associate the user identification with the local shopper category.

18. The system of claim 11, wherein the local delivery indication detector is to determine that the item indicated in the purchase request is a local delivery item from a local delivery items category, the local delivery items category maintained by the on-line trading platform.

19. The system of claim 11, wherein the purchase request is received from a mobile device.

20. A machine-readable non-transitory storage medium having instruction data to cause a machine to:
receive, from a user represented by a user identification, a purchase request indicating an item available for purchase via an on-line trading platform, the on-line trading platform maintaining local courier profiles representing respective providers of local courier service, the local courier profiles comprising respective quality of service ratings generated based on feedback provided by users of the on-line trading platform;
determine from the purchase request, an indication of a local delivery transaction;
select courier identifications corresponding to one or more profiles from the local courier profiles, in response to the indication of the local delivery transaction, utilizing respective quality of service ratings stored in the local courier profiles; and
provide, to the user, a list of the selected courier identifications corresponding to one or more profiles from the local courier profiles.
